(19) United States
(12) Patent Application Publication
(10) Pub. No.: US 2006/0172648 A1
(43) Pub. Date: Aug. 3, 2006

(54) Method and material for stabilizing a wall or surface

(75) Inventors: Ronald C. Amos, Big Pool, MD (US); Michael J. Henderson, Shepherdstown, WV (US)

Correspondence Address: DINESH AGARWAL, P.C., 5350 SHAWNEE ROAD, SUITE 330, ALEXANDRIA, VA, 22312, US

(73) Assignee: PlasterLoc, LLC

(21) Appl. No.: 11/046,809

(22) Filed: Feb. 1, 2005

(51) Int. Cl. D21H 11/00; B32B 15/14; B32B 27/12

(52) U.S. Cl. 442/378; 162/105; 442/376; 442/394

(57) ABSTRACT

Method and material for stabilizing a wall or surface, such as a plaster wall or plaster surface, includes a laminate having first and second layers of a fibrous material, and metallic and polymeric material layers disposed between the first and second layers. The method includes repairing any damaged areas of a wall or surface, and then applying the laminate to the entire wall or surface, including the repaired areas, and allowing the laminate to cure and stretch and shape over the surface character marks, imperfections, etc., to maintain the original character and appearance of the wall, and prevent the appearance of any new cracks or other damage on the wall surface.

### FIELD AND BACKGROUND OF THE INVENTION

The present invention is generally directed to repairing or stabilizing walls and surfaces, and more particularly to stabilizing a repaired plaster wall or plaster surface while maintaining its surface character marks externally visible.

In modern times, in the building of residential homes, commercial buildings, and other structures, walls such as ceilings, side walls and the like, are typically built by erecting or laying wood frames made of joists or studs. The frames are then covered by fastening plasterboard or drywall, or the like to the joists or studs. The joints between the boards are then covered with plaster, tape or the like, and then the surface is finished by painting, wallpapering, etc. Frequently, the wall frames are prefabricated as wall units, which are then assembled into a complete structure, as described.

However, prior to the 1930s or 40s, a versatile material known as “plaster”, was more commonly used to finish the walls, ceilings, etc. Not only did the plaster provide a durable surface that was easy to clean, it could be easily applied to flat or curved walls or ceilings. Its versatility resided in the fact that it can be applied over brick, stone, half-timber or frame construction. A further advantage of using plaster was that it could be treated or finished in a variety of ways, including receiving stenciling, decorative painting, wallpaper, or whitewash, etc. It was because of all of these advantages that plaster was the choice for the wall surface for nearly all buildings until the 1930s or 40s. (MacDonald, M L, Preservation Brief 21:Repairing Historic Flat Plaster—Walls and Ceilings, http://www2.cr.nps.gov/tps/briefs/brief21.htm).

Although in modern construction, plasterboard sheets or drywall has become the choice material for finishing the walls, ceilings, etc., many buildings, structures, etc., historic or otherwise, still exist that have plaster surfaces. Considering that plaster is the visual history of the interior of a structure, whether a family farmhouse or a revered historical building, the need to retain the original appearance is most desirable. However, maintaining plaster, historic or otherwise, is an ongoing problem constantly facing the owners of all structures. Moisture, vibration, deterioration, original poor workmanship, materials, etc., cause plaster to crack or loosen, while salts in the masonry substrate migrate to the surface causing dry bubbles and surface deterioration. Plaster loosens from the underlying wooden lath strips, or the lath strips loosen from the structural members because of the fastener (nail) failure. The temperature and humidity extremes also cause expansion and contraction of the underlying structural members causing cracks over the plaster surface resulting in tearing of historic and expensive wall coverings. All of these make plaster repair an expensive, and a never ending problem.

Historically, plaster repair consisted of covering cracks, voids and dry bubbles with various drywall or plaster joint compounds along with fiber glass mesh tape. The repaired area was then painted. Any loose plaster was removed and the wood filled with new plaster or sheetrock and the above repair was performed. Unfortunately, the repairs were usually short-lived, and cracks or loosening would soon appear in another area of the wall or ceiling requiring the expensive process to be repeated. Each repair process requires re-painting and/or replacement of historic and expensive wall covering. In addition, since plastering is a skilled craft with only a limited number of trained artisans, and most repairs are beyond the capabilities of the typical handyman, plaster repairs are quite expensive.

On the other hand, the most common damage to a modern drywall is the result of holes being created when objects such as doors without doorstops allow the doorknob to hit the unprotected wall board and the damage results. Other damage is typically created by furniture or other large objects creating a dent in the wall surface. Typically, the surface damage is repaired with a wall compound, and the holes are patched with various commercially available products that provide a rigid surface to cover a hole, apply coats of wall compound, and sanding and painting the surface. To repair a larger damage, the entire dry wall is replaced. Typically, a rigid sheet of material or patch is required to repair a hole or larger damage.

Various patches and wall structures are available in the art as shown in U.S. Patents/Publications Nos. U.S. Pat. Nos. 1,838,237; 3,859,766; 4,135,017; 4,358,495; 5,620,768; 5,820,958; 6,231,949 B1; 6,607,621 B1; 6,627,292 B1; and 2003/0126819A1. However, the prior art patches or wall structures are not effective in repairing plaster walls or surfaces. For instance, while the patches may be effective in repairing dents, holes, cracks, or other similar flaws in a wall, they do not stabilize the entire wall. As noted above, covering cracks, holes, etc., with conventional drywall or plaster joint compounds often led to repeating the entire repair process. In addition, the use of conventional materials did not lead to maintaining the historic surface character marks externally visible, an extremely desirable aspect in maintaining the original appearance of a wall, ceiling, or the like.

In view of the drawbacks associated with the conventional techniques, materials and devices, there is a need in the industry for a technique and material for stabilizing a wall or surface, and particularly a plaster wall or plaster surface.

### OBJECTS AND SUMMARY OF THE INVENTION

An object of the present invention is to provide a method and material for repairing or stabilizing a wall or surface, such as a plaster wall or plaster surface.

Another object of the present invention is to provide a material for repairing or stabilizing a wall or surface, such as a plaster wall or plaster surface, while maintaining the surface imperfections, features, or character marks externally visible after the repair or stabilization.

Yet another object of the invention is to provide a material for repairing or stabilizing a wall or surface which functions as a moisture barrier.

Still yet another object of the present invention is to provide a material for repairing or stabilizing a wall or surface which functions to encapsulate or entrap harmful or undesirable contaminants or airborne agents that may exist in the wall or on the surface thereof.

An additional object of the present invention is to provide a material which can be used to stabilize an entire wall or surface, such as a plaster wall or plaster surface.

Yet an additional object of the present invention is to provide a material for stabilizing a repaired wall or surface while preserving the original character and appearance thereof.

Still yet an additional object of the present invention is to provide a material for repairing or stabilizing a wall or surface, such as a plaster wall or plaster surface, which eliminates or significantly reduces the need for constant or repetitive repair of the wall or surface, while preserving the historic character and appearance of the wall or surface.

A further object of the present invention is to provide a material which when secured to a wall or surface, such as a plaster wall or plaster surface, creates a surface tension over the entire wall or surface thereby preventing or significantly reducing any loose section of plaster or other wall material from dislodging, and further hiding any cracks.

Yet a further object of the present invention is to provide a material for repairing or stabilizing a wall or surface, such as a plaster wall or plaster surface, which is compatible with various paints, wall coverings, materials, etc.

Still yet a further object of the present invention is to provide a material which, although specially suited for repairing or stabilizing a plaster wall or plaster surface, can also be used on modern day materials, such as plasterboards, drywalls, stone walls, etc.

Another object of the present invention is to provide a material which can be used to stabilize a wall or surface, with or without any damage, while maintaining its surface or other character marks externally visible.

In summary, the main object of the present invention is to provide a technique and material for repairing or stabilizing a wall or surface, such as a plaster wall or plaster surface, while maintaining the surface imperfections, marks, or appearance externally visible.

In accordance with an aspect of the present invention, a laminate for stabilizing a wall or surface, includes first and second layers of a fibrous material, and a metallic material layer and a polymeric material layer disposed between the first and second layers.

In accordance with another aspect of the present invention, a method of stabilizing a repaired plaster wall or plaster surface, while maintaining its surface character marks externally visible, includes applying an adhesive over an entire plaster wall or plaster surface including a repaired area, providing a stabilizer laminate having first and second layers of a fibrous material and a metallic material layer and a polymeric material layer disposed between the first and second layers, securing the stabilizer laminate over the entire plaster wall or plaster surface, and allowing the adhesive to cure. Whereby upon curing, the stabilizer laminate stretches over the plaster wall or plaster surface and shapes over any surface character marks thereby keeping them externally visible.

In accordance with another aspect of the present invention, a method of repairing and stabilizing a damaged plaster wall or plaster surface, while maintaining its surface character marks externally visible, which includes repairing any cracks or voids in a damaged area of a plaster wall or plaster surface by using a suitable compound, applying an adhesive over the entire plaster wall or plaster surface, providing a stabilizer laminate having a first and second layers of a fibrous material and a metallic material layer and a polymeric material layer disposed between the first and second layers, securing the stabilizer laminate over the entire plaster wall or plaster surface, and allowing the adhesive to cure. Whereby upon curing, the stabilizer laminate stretches over the plaster wall or plaster surface and shapes over any surface character marks thereby keeping them externally visible.

In accordance with another aspect of the present invention, a method of stabilizing a wall or surface, while maintaining its character marks externally visible, includes applying an adhesive over an entire wall or surface including one or more character marks, providing a stabilizer laminate having first and second layers of a fibrous material and a metallic material layer and a polymeric material layer disposed between the first and second layers, securing the stabilizer laminate over the entire wall or surface, and allowing the adhesive to cure. Whereby upon curing, the stabilizer laminate stretches over the wall or surface and shapes over any character marks thereby keeping them externally visible.

### BRIEF DESCRIPTION OF THE DRAWINGS

One of the above and other objects, novel features and advantages of the present invention will become apparent from the following detailed description of the preferred embodiment(s) of invention, illustrated in the drawings, in which:

FIG. 1 illustrates a plaster wall with cracks and damage to finish and base coats, and showing surface character marks;

FIG. 2 is a view similar to FIG. 1, showing the plaster wall repaired and stabilized by using the material of the invention, and showing the original surface character marks;

FIG. 3 illustrates finishing of a plaster wall;

FIG. 4 is an enlarged, fragmentary left end view of the wall shown in FIG. 3;

FIG. 5 is a view similar to FIG. 4, showing various stages of hidden damage to a plaster wall;

FIG. 6 illustrates continuation of the hidden damage to the plaster wall shown in FIG. 5, leading to falling-off of a portion of the plaster;

FIG. 7 illustrates the stabilizer laminate of the present invention, showing various layers thereof;

FIG. 8 is a cross-sectional view taken along line 8-8 of FIG. 7; and

FIG. 9-11 illustrate in end views the sequence of repairing and stabilizing a damaged plaster wall.

### DETAILED DESCRIPTION OF THE PREFERRED EMBODIMENT(S) OF THE INVENTION

The present invention can be better understood by first reviewing the manner in which a plaster wall is created or finished, and the subsequent damage that results over time due to various reasons, noted above.

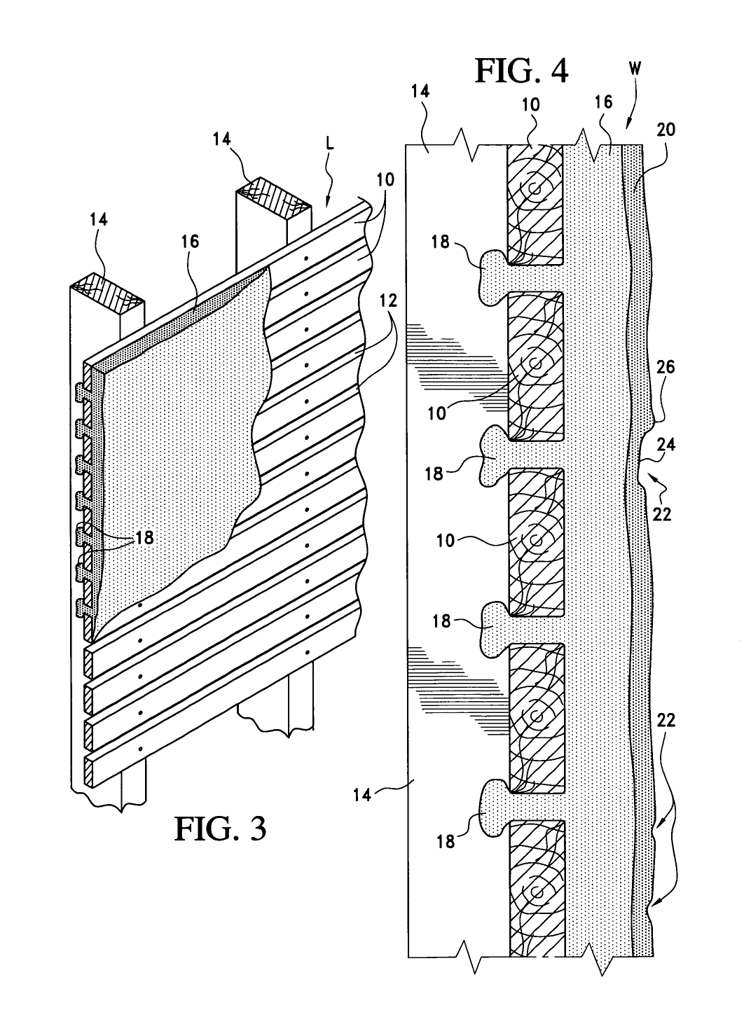

Referring to FIGS. 3 and 4, a wooden lath L made up of narrow, thin strips 10 of wood with spaces 12 in between, is nailed at a right angle directly to the joists or studs 14 of a building. A base coat 16 of plaster is applied on the lath L and is pushed through the spaces 12. (The base coat is also known as “scratch” or “brown coat” in the industry.) As the base coat 16 pushes through the spaces 12, it forms globs or keys 18, which upon drying hold the plaster to the lath L. A final or finished coat of plaster 20 is subsequently applied to finish the wall W.

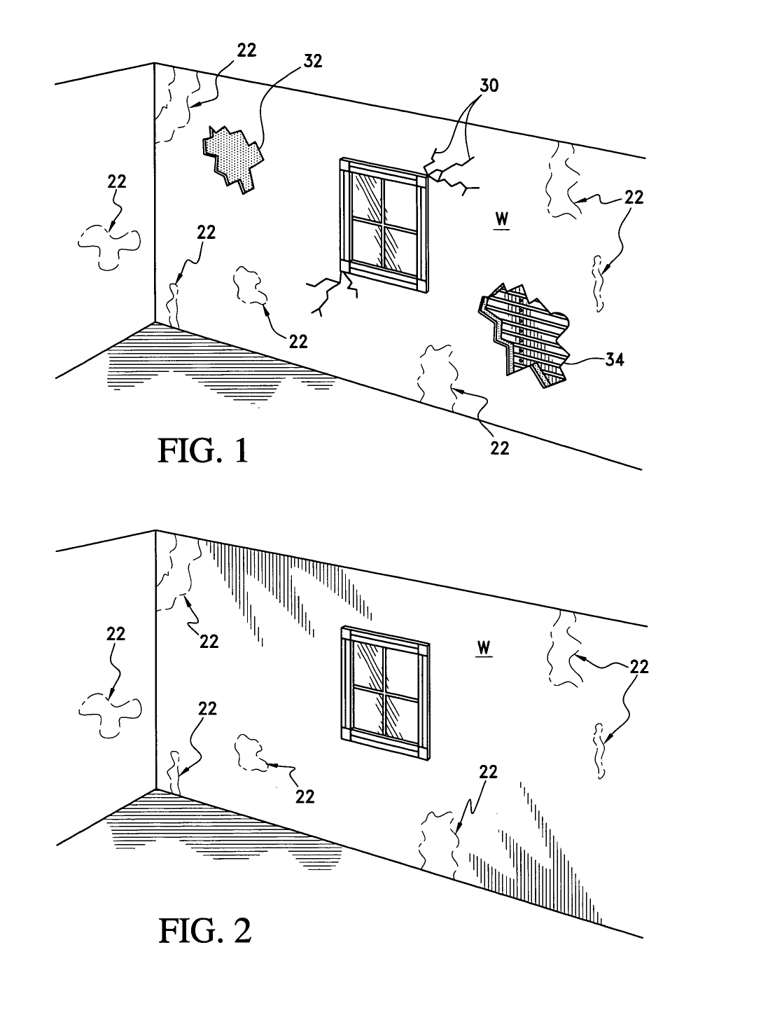

Although plastering is a skilled craft, it is mostly done manually without utilizing any sophisticated equipment, machinery, etc. Further, the plaster is typically applied on successive days to obtain the required wall thickness. As a result, the thickness and/or surface of the base and finished coats 16 and 20 are generally uneven or irregular. This produces surface character marks 22 unique to each particular wall or surface (see FIGS. 1-2 and 4, for example). Generally, the surface marks 22 are in the form of depressions 24 and raised areas 26. The character marks may also be created or formed due to damage to the wall by other use-related incidences, such as furniture damage, gun shots, or settling of the structure, and subsequent repair thereto by the owners, occupants, etc.

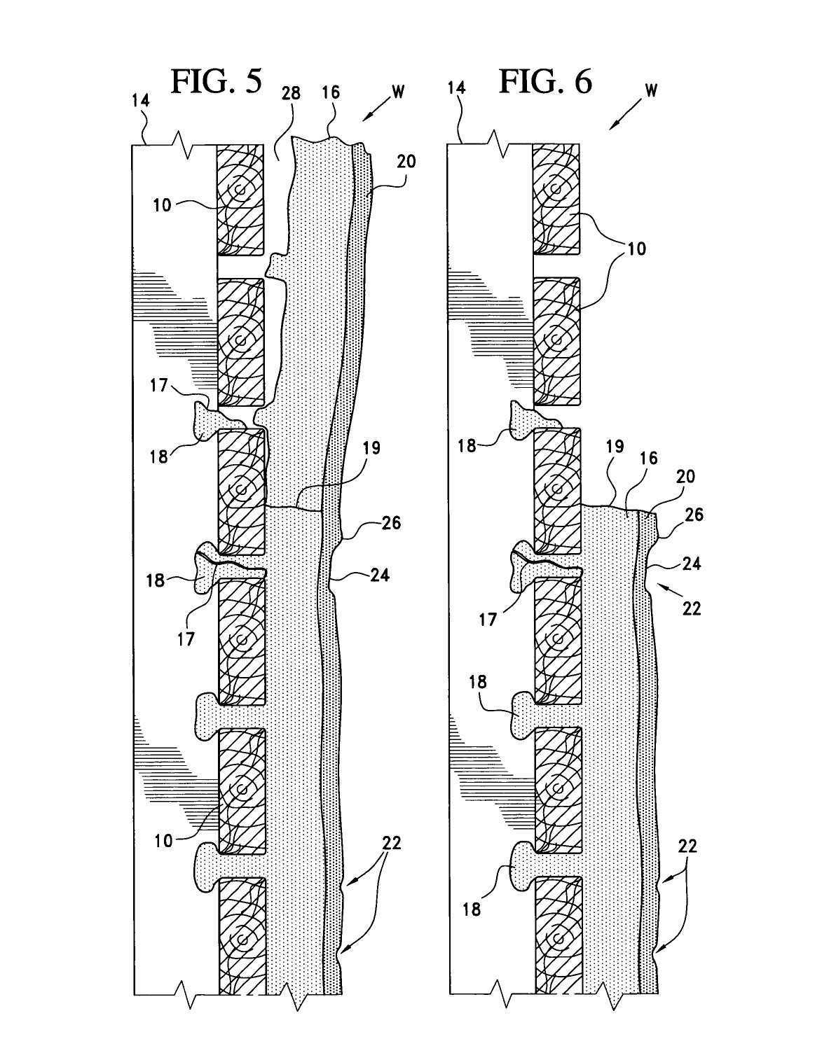

As the plaster dries and over time, cracks 17 develop in the keys 18 causing them to break loose from the base coat 16 (FIG. 5). As more keys 18 break off, the plaster wall W pulls loose from the lath L creating a void 28 between the base coat 16 and the strips 10. The entire plaster (or a portion thereof) becomes bowed, develops cracks 19, and ultimately falls from the wall W (FIG. 6).

As best shown in FIGS. 1 and 9, the more common visible damage that occurs to a plaster wall over time is the formation of cracks 30 in base and/or finished coats 16 and 20, delamination 32 of finished coat 20 from the base coat 16, and complete loss of both the finished coat 20 and the base coat 16 leading to voids 34. In order to repair the damage, conventionally the cracks 30 are filled with a commercial drywall or plaster compound. Likewise, to repair the voids 32 and 34, any loose plaster there around is first removed and the voids are filled with new plaster or sheet rock and sanded and painted. In other words, the damaged areas are repaired and the wall is finished. As noted above, this technique of repairing the damage leads to subsequent formation of cracks and loosening of other area(s) of the wall or ceiling, requiring repeating the repair process.

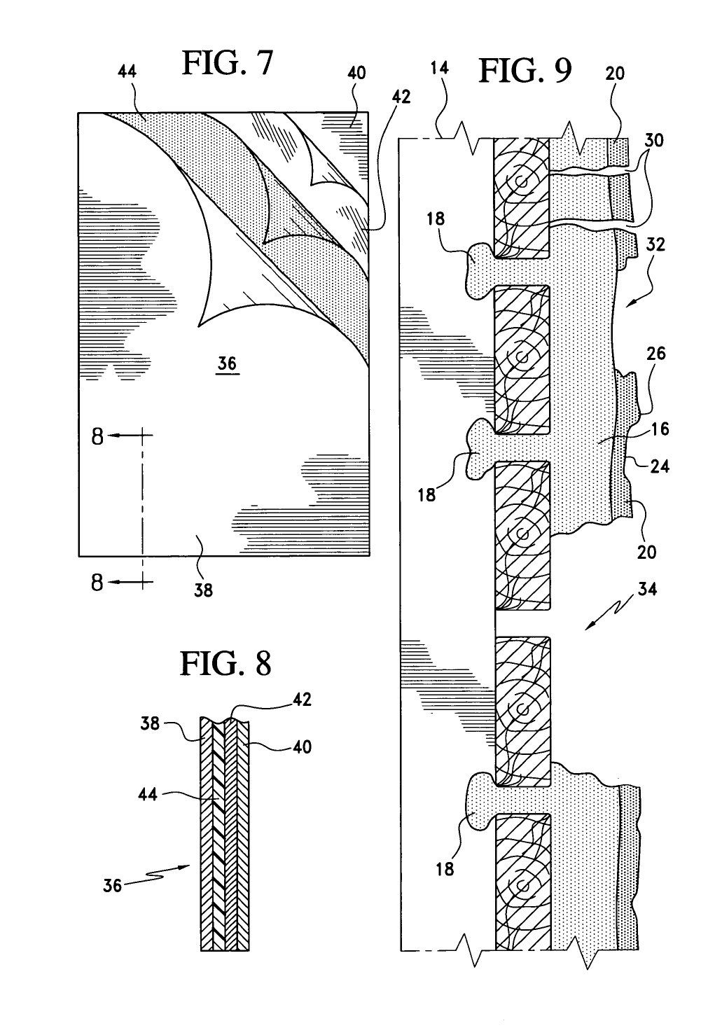

The present invention will now be described. As best shown in FIGS. 7-8, the material for repairing or stabilizing a wall or surface is preferably in the form of a flexible laminate 36, which includes top and bottom layers 38 and 40 of a fibrous material, such as kraft paper. Preferably, the kraft paper has a thickness of 25-35 lbs. A thin metallic material layer 42 and a polymeric material layer 44 are sandwiched between the top and bottom layers 38 and 40. Preferably, the metallic layer 42 is formed of aluminum foil having a thickness of about 0.0005-0.0010 mil. Most preferably, the thickness of the aluminum foil is about 0.0007 mil. Likewise, the polymeric material layer 44 is formed of a thermosetting or thermosetting polymer, such as a polyester resin or polypropylene. Most preferably, the polymeric material layer 44 is made of Mylar® (Dupont). The preferable thickness of the polymeric material layer 44 is about 0.5 to 1.5 mil., with the most preferable being about 1.0 mil.

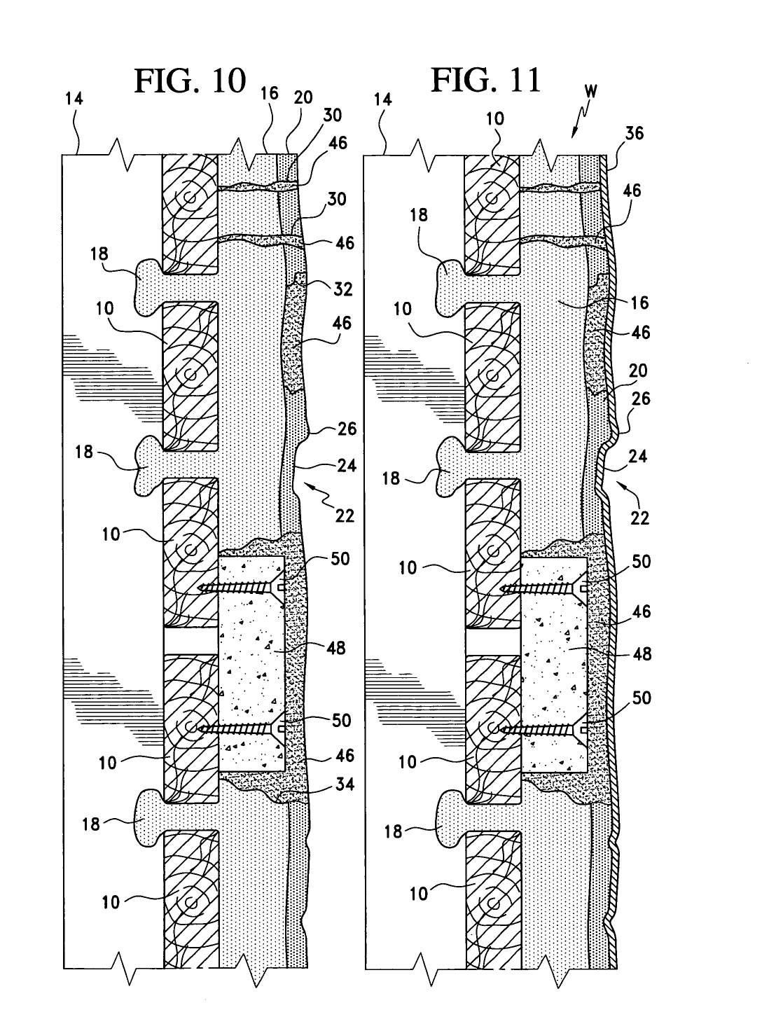

The manner of repairing and/or stabilizing the plaster wall W will now be described by referring to FIGS. 9-11. The cracks 30 that run through one or both of the base coat 16 and the finished coat 20, are filled with a suitable drywall finishing compound 46 (FIG. 10). The delamination or void 32 in the finished coat 20 is also filled with the drywall compound 46. In order to fill the void 34 that extends through the base coat 16 and the finished coat 20, a piece of sheet rock or the like material 48 is cut to fit in the void 34. The sheet rock piece 48 is then screwed onto the strips 10 by using conventional screws 50. The void 34 is then filled with the drywall compound 46. The stabilizer laminate 36 of the present invention is then installed over the entire wall W, including the repaired areas, by using a suitable adhesive and finished in a conventional manner, such as the technique for installing a wallpaper (FIG. 11). As the adhesive cures, the laminate 36 recesses into the surface depressions 24, or stretches over the raised areas 26, to assume the shape or configuration of the surface character marks 22, thereby maintaining the original character and appearance of the wall W externally visible (FIGS. 11 and 2). In addition, the stabilizer laminate 36 stretches over the entire wall surface creating a surface tension thereon, thereby preventing any loose section of plaster or other material from dislodging, and further hiding any other surface cracks or fine damage.

It is noted herewith that since the stabilizer laminate 36 of the invention is applied over the entire wall surface, the wall W is stabilized in terms of any loose plaster, or other wall or surface material from dislodging off of the wall, in addition to the repaired areas.

As can be seen from the above, the stabilizer laminate 36 of the present invention allows restoration of walls and surfaces, and particularly historical plaster walls and surfaces, while maintaining the historic character and appearance thereof. In this regard, one of ordinary skill in the art would appreciate that a plaster wall or plaster surface cannot be stabilized by using the conventional materials or techniques, such as those used to repair damage to modern drywall or the like, without sacrificing the most desirable surface character marks, imperfections, etc., typically inherent in a historic plaster wall or plaster surface. On the other hand, the stabilizer laminate 36 of the present invention can be easily used to repair and/or stabilize any wall or surface, such as plasterboard, drywall, stone wall, or the like.

It is further noted herewith that the stabilizer laminate 36 of the present invention can also be used to stabilize a wall or surface, with or without any damage, while maintaining its surface or other character marks externally visible.

While this invention has been described as having preferred sequences, ranges, steps, materials, structures, components, features, and/or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbeforesetforth and fall within the scope of the invention and of the limits of the appended claims.

What is claimed is:

1. A laminate for stabilizing a wall or surface, comprising:
a) first and second layers of a fibrous material; and
b) a metallic material layer and a polymeric material layer disposed between said first and second layers.

2. The laminate of claim 1, wherein:
a) the fibrous material comprises kraft paper.

3. The laminate of claim 1, wherein:
a) the fibrous material comprises 25-35 pound kraft paper.

4. The laminate of claim 2, wherein:
a) the metallic material layer comprises a thin layer of aluminum.

5. The laminate of claim 4, wherein:
a) the aluminum layer is about 0.0005-0.0010 mil. in thickness.

6. The laminate of claim 4, wherein:
a) the polymeric material layer comprises a thermosetting or thermoplastic polymer.

7. The laminate of claim 4, wherein:
a) the polymeric material layer comprises a polyester resin or polypropylene.

8. The laminate of claim 4, wherein:
a) the polymeric material layer comprises polyester.

9. The laminate of claim 8, wherein:
a) the polyester layer is about 0.5-1.5 mil. in thickness.

10. A method of stabilizing a repaired plaster wall or plaster surface while maintaining its surface character marks externally visible, comprising:
a) applying an adhesive over an entire plaster wall or plaster surface including a repaired area;
b) providing a stabilizer laminate, comprising:
i) first and second layers of a fibrous material; and
ii) a metallic material layer and a polymeric material layer disposed between the first and second layers;
c) securing the stabilizer laminate over the entire plaster wall or plaster surface and allowing the adhesive to cure;
d) whereby upon curing the stabilizer laminate stretches over the plaster wall or plaster surface and shapes over any surface character marks thereby keeping them externally visible.

11. The method of claim 10, wherein:
the fibrous material comprises kraft paper.

12. The method of claim 10, wherein:
the fibrous material comprises 25-35 pound kraft paper.

13. The method of claim 11, wherein:
the metallic material layer comprises a thin layer of aluminum.

14. The method of claim 13, wherein:
the aluminum layer is about 0.0005-0.0010 mil. in thickness.

15. The method of claim 13, wherein:
the polymeric material layer comprises a thermosetting or thermoplastic polymer.

16. The method of claim 13, wherein:
the polymeric material layer comprises a polyester resin or polypropylene.

17. The method of claim 13, wherein:
the polymeric material layer comprises polyester.

18. The method of claim 17, wherein:
the polyester layer is about 0.5-1.5 mil. in thickness.

19. A method of repairing and stabilizing a damaged plaster wall or plaster surface while maintaining its surface character marks externally visible, comprising:
a) repairing any cracks or voids in a damaged area of a plaster wall or plaster surface by using a suitable compound;
b) applying an adhesive over the entire plaster wall or plaster surface;
c) providing a stabilizer laminate, comprising:
i) first and second layers of a fibrous material; and
ii) a metallic material layer and a polymeric material layer disposed between the first and second layers;
d) securing the stabilizer laminate over the entire plaster wall or plaster surface and allowing the adhesive to cure;
e) whereby upon curing the stabilizer laminate stretches over the plaster wall or plaster surface and shapes over any surface character marks thereby keeping them externally visible.

20. A method of stabilizing a wall or surface while maintaining its character marks externally visible, comprising:
a) applying an adhesive over an entire wall or surface including one or more character marks;
b) providing a stabilizer laminate, comprising:
i) first and second layers of a fibrous material; and
ii) a metallic material layer and a polymeric material layer disposed between the first and second layers;
c) securing the stabilizer laminate over the entire wall or surface and allowing the adhesive to cure;
d) whereby upon curing the stabilizer laminate stretches over the wall or surface and shapes over any character marks thereby keeping them externally visible.
